(19) United States
(12) Patent Application Publication
(10) Pub. No.: US 2008/0268841 A1
(43) Pub. Date: Oct. 30, 2008

(54) Method of Registering a Battery-Powered Device in a Wireless Network

(75) Inventor: Engel Johannes Knibbe, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,594

(22) PCT Filed: Jul. 24, 2006
(86) PCT No.: PCT/IB2006/052525

§ 371 Date: Jul. 10, 2008

(30) Foreign Application Priority Data
Jul. 26, 2005 (EP) 05106929.2

(51) Int. Cl. H04Q 7/20

(52) U.S. Cl. 455/435.1

(57) ABSTRACT

Registering or reconfiguring a battery-powered device in a network, comprising monitoring the occurrence of an event in the device during its idle state, i.e. the occurrence of an idle interval time-out during which the device is held in the idle state. When the device has detected said event, it is put into an initiation state for the duration of an initiation interval in which the device initiates a registration procedure. If the initiation interval ends without proper response to the initiation of the registration procedure, the idle state during idle intervals alternates with the initiation state during initiation intervals until the device has entered the state of normal operation.

### FIELD OF THE INVENTION

The invention relates to a method as described in the pre-characterizing part of claim 1.

### BACKGROUND OF THE INVENTION

U.S. Pat. No. 6,859,644 discloses a method of initializing system components of a wireless-controlled lighting system comprising a remote control, a plurality of lighting units and a control master. When a button on the remote control is pressed, the remote control will initiate a registration procedure in which it transmits a request to the control master, indicating that it wants to join the system. Similarly, powering up a lighting unit will initiate a registration procedure in which this unit transmits a request to the control master, indicating that it wants to join the system. Through proper communication, the control master assigns and transmits identity numbers to the devices requesting to join the system.

The invention particularly relates to battery-powered devices. More particularly, the invention relates to such devices which communicate with other system components by two-way radio transmission. An architecture known as Zigbee currently complies with such a system. A description of the Zigbee architecture can be found on http://embedded.com//showArticle.jhtml?articleID=18902431. The Zigbee architecture comprises a network coordinator, subordinate full function devices (FFDs) and subordinate reduced function devices (RFDs). Particularly the RFDs are battery-powered sensor devices. Such devices must have an extremely low energy consumption so as to maximally utilize the energy contained in their batteries.

Currently, the battery-powered devices of a system or network with a Zigbee architecture are registered in the network by the same method as disclosed in U.S. Pat. No. 6,859,644 described above.

The prior-art method has several disadvantages.

It may be difficult or troublesome for a person to initiate a procedure for registering a device in a system by triggering an event, such as pressing a button of the device, or activating a motion detector or other sensor by movement of the person.

It takes time to complete the construction of a system of the type mentioned above. Throughout this time, unregistered devices are trying to register in the system and thus consume a lot of energy.

If a registration procedure is initiated upon inserting a battery in a battery-powered device, such a device cannot be kept in stock or installed without losing energy until it is actually registered.

A greater complexity of the system built or to be built aggravates such disadvantages.

### OBJECT AND SUMMARY OF THE INVENTION

It is an object of the invention to solve the drawbacks of the prior art as described above.

The object of the invention is achieved by providing a method as defined in claim 1.

Accordingly, the registration procedure can be repeatedly initiated by a repeated simple time-out event without intervention by a person and without loss of energy for the time between such time-outs if there is no response to the initiation of the registration procedure.

The object of the invention is also achieved by providing a battery-powered radio-frequency (RF) device as defined in claim 8.

### BRIEF DESCRIPTION OF THE DRAWINGS

FIG. 1 is a schematic representation of an embodiment of a battery-powered radio-frequency (RF) device according to the invention.

### DESCRIPTION OF EMBODIMENTS

The invention will be apparent from the following description.

According to the invention, battery-powered devices of a system of the type mentioned above are kept in an idle state during idle intervals which alternate with initiation intervals, during which such a device is in an operating state and initiates a registration procedure.

The registration procedure may be initiated by transmitting a request for registration by the device which wants to be registered (or commissioned or joined) in the system. Such a request may be received by another appropriate system component, such as an FFD of a Zigbee architecture, which is authorized to register the requesting device. Upon reception of the request, said other component may respond by transmitting a reply. When the device has received the reply, the device and said other component may proceed with the registration procedure. The device is kept in the initiation state during the time an initiated registration procedure is running. After it has been registered, the device is put and maintained in a normal state of operation.

Since the registration procedure itself is not a subject of the invention, it will not be described here.

If the device does not receive a proper reply to its request for registration before the end of an initiation interval, the device is put into an idle state throughout an idle interval. Upon a time-out of the idle interval, the device is put into the initiation state again for initiating the registration procedure, and so forth.

Instead of transmitting a request for registration immediately after entering the initiation state from the idle state, the device may wait for the reception of a timing beacon, which may be sent at intervals by another component, such as an FFD of a Zigbee architecture. After it has received such a timing beacon, the device may transmit its request for registration. The procedure may further be the same as described hereinbefore.

The system to be built may be a complex system comprising many devices (battery-powered or powered by other means) to be installed at locations which may be easy or difficult to reach, such as in office buildings and factories. This indicates that it may take a long time before the system is completed and can be put into operation. Therefore, and preferably, the duration of the idle interval is made dependent on the time expected to be needed for completing the system.

For applying the method in a complex system, the idle interval may be chosen to be one hour.

For applying the method in a domestic system, the idle interval may be chosen to be ten minutes.

The initiation interval needs to last just long enough to transmit a registration request and receive a reply to the request. An initiation interval of 50 ms may be sufficient. If a waiting time for receiving a beacon has to be observed, the initiation interval may be chosen to be a little longer than an interval between two successive beacons.

The method according to the invention ensures that battery-powered devices can save a large amount of energy contained in their batteries. Moreover, the event which initiates a registration procedure is simple and user-friendly. Above all, it does not require human presence for all devices of the system.

A RF device in which the method of the invention can be applied comprises a RF transmitter and a RF receiver, a monitoring part, which monitors the occurrence of an event of a type which is associated with a request for registering the device in the network, and a processing part, which is suitable for initiating a registration procedure when the monitoring circuit detects said event, upon which the processing part controls the transmitter to transmit a registration request, to carry out a registration procedure when a proper response to the transmitted registration request has been received via the receiver, and to enter the device from a pre-registered state into a state of normal operation after it has been registered in the network during the registration procedure. In addition, the RF device comprises a timer, which, during the pre-registered state, generates alternating idle intervals and initiation intervals, wherein the processing part is arranged to put the device into an idle state if the device is not yet registered in the network and the processing part handles the occurrence of an initiation interval as the event by which it initiates the registration procedure.

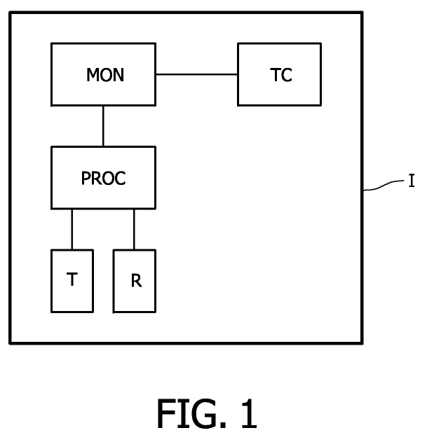

Such a RF device is shown in FIG. 1. T is the transmitter and R is the receiver. PROC is the processing part and MON is the monitoring part. TC is the timer.

The RF device may be constructed in many different ways by means of analog and/or digital techniques known to a skilled person.

After a device has been registered in the system, the system or a person may wish to reconfigure the device. Under circumstances, e.g. when the device is an intruding sensor device, it may take a long time, if not perpetually, for the device to communicate with the rest of the system. Throughout this time, the device is in an idle state, i.e. it is not even listening to communication requests. This can be alleviated by letting the device request the system for reconfiguration data, if any, with intervals. Reconfiguration can be considered as registering a possibly different device (to be modified) in the system. In the appended claims, the registration procedure is therefore also understood to cover a reconfiguration procedure.

1. A method of registering a battery-powered device in a network of several RF devices, the method comprising the steps of:
monitoring the occurrence of an event of a type which is associated with such a registration in the device to be registered, and
upon detecting the occurrence of such an event, putting the device into an initiation state for initiating a registration procedure with another device, and
when having been registered, entering the device into a state of normal operation,
characterized in that the event is the occurrence of an idle interval time-out during which the device is put into an idle state, the registration procedure is initiated during an initiation interval following the idle interval, and the idle state during idle intervals alternates with the initiation state during initiation intervals until the device has entered the state of normal operation.

2. A method according to claim 1, characterized in that, upon initiating the registration procedure, the device transmits a request for registration and subsequently waits for a reply to the request during the initiation interval.

3. A method according to claim 1, characterized in that, upon initiating the registration procedure, the device waits for the reception of a timing beacon during the initiation interval.

4. A method according to claim 1, characterized in that the initiation interval has a duration of less than 50 ms.

5. A method according to claim 1, characterized in that the idle interval has a duration which is made dependent on the number of devices of the network.

6. A method according to claim 1, characterized in that the idle interval has a duration of one hour.

7. A method according to claim 1, characterized in that the idle interval has a duration of ten minutes.

8. A battery-powered radio-frequency (RF) device which is suitable for use in a network of several RF devices using two-way RF communication, the device comprising a RF transmitter and a RF receiver, a monitoring part, which monitors the occurrence of an event of a type which is associated with a request for registering the device in the network, and a processing part, which is suitable for initiating a registration procedure when the monitoring circuit detects said event, upon which the processing part controls the transmitter to transmit a registration request, to carry out a registration procedure when a proper response to the transmitted registration request has been received via the receiver, and to enter the device from a pre-registered state into a state of normal operation after the device has been registered in the network during the registration procedure, characterized in that the device further comprises a timer which generates alternating idle and initiation intervals during the pre-registered state, the processing part putting the device into an idle state during an idle interval, and the occurrence of an initiation interval providing the event used by the processing part to initiate the registration procedure.

9. A device according to claim 8, characterized in that the monitoring part and the processing part are arranged to wait for the reception of a response to a transmitted registration request for the duration of the initiation interval.

10. A device according to claim 8, characterized in that the processing part is arranged to let the transmitter transmit the registration request after reception of a timing beacon by the receiver during the initiation interval.

11. A device according to claim 8, characterized in that the initiation interval has a duration of less than 50 ms.

12. A device according to claim 8, characterized in that the idle interval has a duration which is made dependent on the number of devices of the network.

13. A device according to claim 8, characterized in that the idle interval has a duration of one hour.

14. A device according to claim 8, characterized in that the idle interval has a duration of ten minutes.
